(19) United States
(12) Patent Application Publication
(10) Pub. No.: US 2007/0192696 A1
(43) Pub. Date: Aug. 16, 2007

(54) Method and apparatus of displaying hierarchically structured file in information terminal

(75) Inventors: Tae-Won Um, Seoul (KR); Hyun-Kyung Shin, Seoul (KR); Il-Geun Bok, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/698,805

(22) Filed: Jan. 26, 2007

(30) Foreign Application Priority Data
Jan. 26, 2006 (KR) 2006-0008073

(51) Int. Cl. G06F 3/00

(52) U.S. Cl. 715/713

(57) ABSTRACT

Provided is a method and an apparatus of searching a hierarchically structured file in an information terminal. The method includes dividing a screen of the information terminal into at least two regions including a first region and a second region; displaying information about the location of a current file and at least one function icon in the first region of the screen, and files included in a current folder in the second region of the screen; and determining whether a key is pressed, and if so, performing a function corresponding to the key input. Therefore, a user can move to a desired location in the hierarchical file more rapidly and exactly, and thus a small-screen can be used more efficiently.

### PRIORITY

This application claims priority under 35 U.S.C. § 119 to an application filed in the Korean Intellectual Property Office on Jan. 26, 2006 and allocated Serial No. 2006-8073, the contents of which are incorporated herein by reference.

### BACKGROUND OF THE INVENTION

1. Field of the Invention

The present invention relates generally to an information terminal, and more particularly, to a method and an apparatus of displaying and searching a hierarchically structured file in an information terminal. A mobile communication terminal is one of the information terminal.

2. Description of the Related Art

The use of mobile communication terminals is increasing very rapidly owing its growth to the convenience of mobility. Mobile communication service providers (or terminal manufacturers) are trying to develop mobile communication terminals having special functions to attract potential users. Examples of such functions include phone book, game, scheduler, short message, Internet access, e-mail, alarm, MPEG Audio Layer-3 (MP3), and digital camera functions.

Meanwhile, two methods are used to search a hierarchically structured file in a mobile communication terminal having a relatively small display. In the first method, left/right/up/down keys enable movement between items, and an action key enables movement to a lower level. This method is commonly used for photo viewers (thumbnail view), mobile terminals, or personal computers (PC). However, this method requires an additional icon for moving to a higher level. In the case of a PC, an additional icon can be easily provided in a predetermined region of a screen since the display of the PC is relatively large. However, in the case of a mobile terminal, the first one of thumbnail images is used as an icon for moving to a parent folder since the screen size of the mobile terminal is small. That is, displaying and searching of a hierarchically structured file is not efficiently performed.

In the second method, left/right keys enable movement to a lower level and a higher level, and up/down keys enable movement between items. This method is commonly used for MP3 players. However, in this method, only an item list is displayed. That is, in this method, useful thumbnail images are not provided for image files, video files, and so on. Therefore, what is needed is an efficient method of displaying and searching a hierarchically structured file in an information terminal having a small screen, such as a mobile communication terminal.

### SUMMARY OF THE INVENTION

An aspect of the present invention is to substantially solve at least the above problems and/or disadvantages and to provide at least the advantages below. Accordingly, an aspect of the present invention is to provide a method and an apparatus of displaying and searching a hierarchically structured file in an information terminal.

Another aspect of the present invention is to provide a method and an apparatus of efficiently displaying and searching a hierarchically structured file in a device having a screen by utilizing a title region.

According to one aspect of the present invention, there is provided a method for displaying and searching a hierarchically structured file in an information terminal, the method includes dividing a screen of the information terminal into at least two regions including a first region and a second region; displaying information about a current hierarchically structured file and at least one function icon in the first region of the screen, and file information of a current folder in the second region of the screen; and determining whether a key input is present, and if so, performing a function corresponding to the key input.

According to another aspect of the present invention, there is provided an apparatus for displaying and searching a hierarchically structured file in an information terminal, the apparatus includes a controller for dividing a screen of the information terminal into at least two regions including a first region and a second region, displaying information about the location of a current file and at least one function icon in the first region of the screen, and files included in a current folder in the second region of the screen, and determining whether a key input is present, and if so, performing a function corresponding to the key input. The display unit displays information outputted from the controller.

### BRIEF DESCRIPTION OF THE DRAWINGS

The above and other aspects, features and advantages of the present invention will become more apparent from the following detailed description when taken in conjunction with the accompanying drawings in which:

FIG. 1 is a block diagram of a mobile communication terminal according to the present invention;

FIG. 2 is a flowchart for explaining a method of searching a hierarchically structured file in an information terminal according to the present invention;

FIGS. 3A and 3B are folder display views for explaining a folder display method according to the present invention;

FIGS. 4A and 4B are views for explaining a method of shifting focus from a content region to a title region according to the present invention;

FIGS. 5A through 5C are views for explaining a function switching method in a title region according to the present invention;

FIGS. 6A and 6B are view for explaining a method of moving to a parent folder according to the present invention;

FIGS. 7A and 7B are views for explaining a method of entirely displaying a folder hierarchically structured according to the present invention; and

FIGS. 8A and 8B are views for explaining a method of moving to a frequently used folder according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

Hereinafter, a method and an apparatus of searching a hierarchically structured file will now be described. In the following description, although a mobile communication terminal is used to explain the method of the present invention, it is not limited to the mobile communication terminal. The present invention can be applied to various devices having a small-sized display.

Examples of the mobile communication terminal include a Cellular Phone, a Personal Communication System (PCS) terminal, a Personal Data Assistant (PDA), and an International Mobile Communication-2000 (IMT-2000) terminal. The following description is made to a general structure of the above terminals.

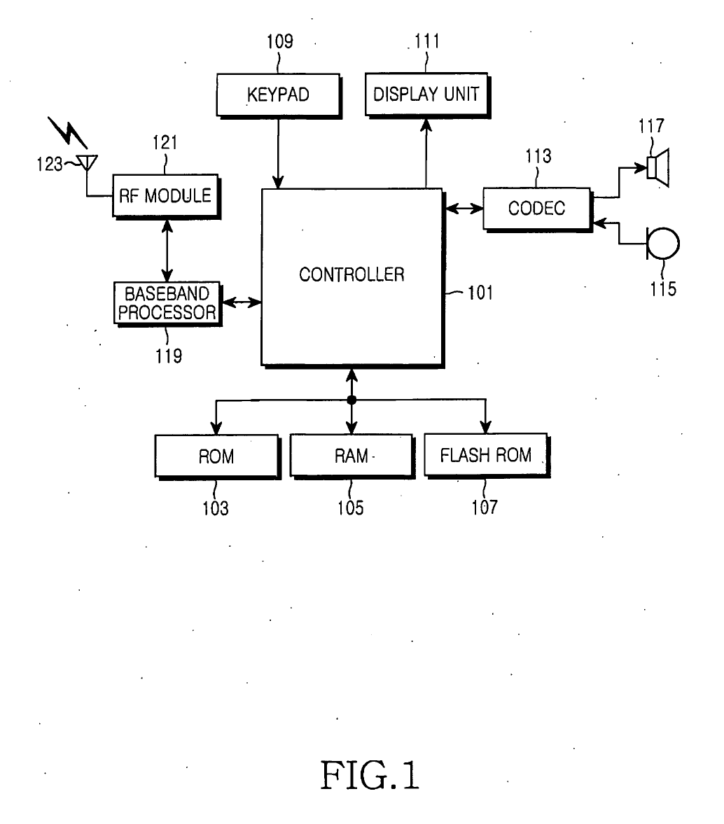

Referring to FIG. 1, a Controller (e.g., a microprocessor unit (MPU)) 101 controls an overall operation of the mobile communication terminal. For example, the Controller 101 processes and controls voice and data communications. In addition to these normal functions, the Controller 101 performs a function for effectively searching a hierarchically structured file using a title region. Since the normal processing and controlling operations of the Controller 101 are well known, descriptions thereof will be omitted.

A Read Only Memory (ROM) 103 stores program micro-codes and reference data for the processing and controlling operations of the controller 101. Particularly, in the present invention, the ROM 103 stores a program for effectively searching the hierarchically structured file using the title region. A Random Access Memory (RAM) 105 is a working memory of the Controller 101 and stores temporary data generated during operations. A Flash ROM 107 stores a variety of updateable backup data.

A keypad 109 includes numeric keys of digits 0-9 and a plurality of function keys, such as a menu key, a cancel (delete) key, a talk key, an end key, an Internet Access key, navigation (or direction) keys (▴/▾/ [symbol] / [symbol] ). When a key (button) is pressed, the keypad 109 sends a corresponding key input signal to the Controller 101. A display unit 111 displays operational status of the mobile communication terminal, text data, moving and still pictures, and the like. A color Liquid Crystal Display (LCD) can be used as the display unit 111.

A Coder-Decoder (CODEC) 113 is connected to the Controller 101, and a Microphone 115 and a Speaker 117 are connected to the CODEC 113. The CODEC 113, the Microphone 115, and the Speaker 117 serve as an audio input/output block that is used for telephony and voice recording. The CODEC 113 converts digital data received from the controller 101 into an analog audio signal to output the analog audio signal through the speaker 117, and converts audio signal received through the Microphone 115 into digital data to output the digital data to the Controller 101.

A Radio Frequency (RF) module 121 down-converts an RF signal received through an antenna 123 to provide the down-converted RF signal to a baseband processor 123, and up-converts a baseband signal provided from the baseband processor 129 to transmit the up-converted baseband signal via the antenna 123. The baseband processor 119 processes baseband signals transmitted between the RF module 121 and the Controller 101. For example, during a transmission operation, the baseband processor 119 channel-codes and spreads data to be transmitted. During a reception operation, the baseband processor 119 despreads and channel-decodes a received signal.

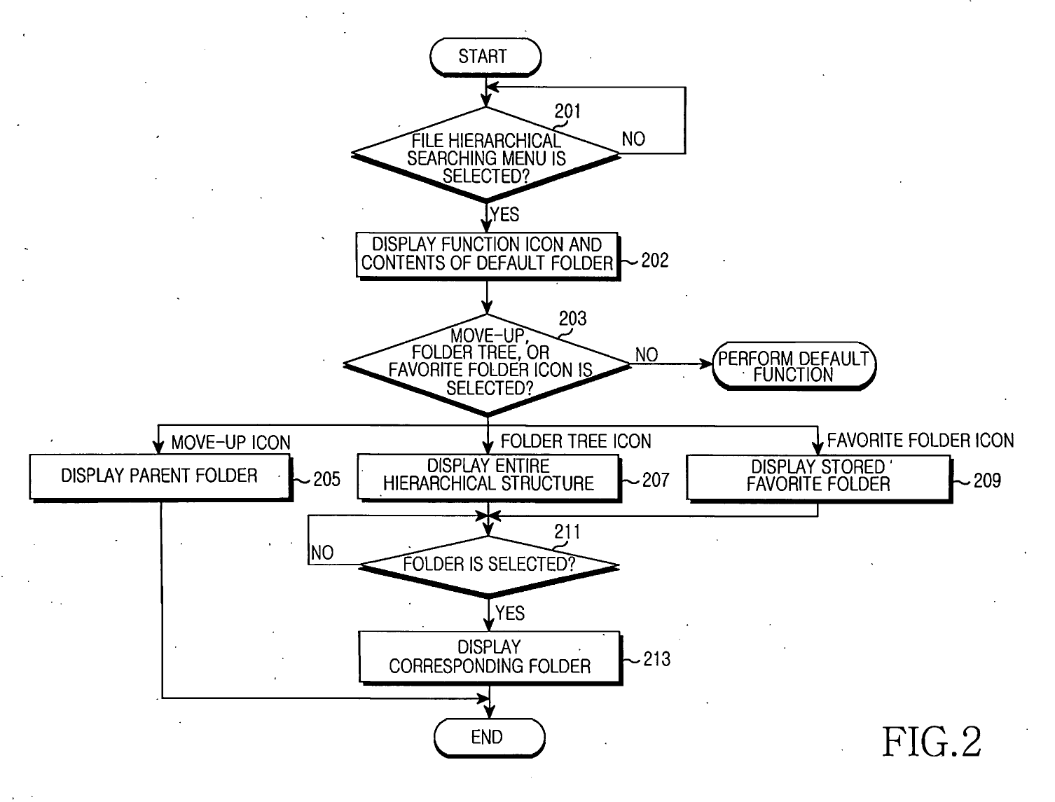

Referring to FIG. 2, the Controller 101 determines in step 201 whether a hierarchically structured file searching menu is selected. If so, the Controller 101 proceeds to step 202 to display a function icon and the contents of a default folder on the display 111. The contents of the default folder can be displayed by a thumbnail view method or a list view method. In the thumbnail view method, images are displayed on the display 111 at a reduced size. In the list view method, a file list is displayed on the display 111.

In step 203, the Controller 101 determines whether a function icon, such as a move-up icon for moving to a parent folder, a folder tree icon for opening a folder tree, and a favorite folder icon for opening a frequently-used folder, is selected.

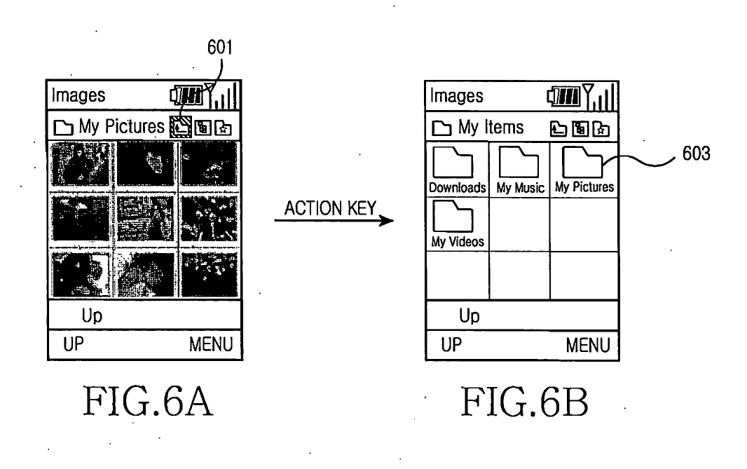

When the move-up icon is selected in step 203, the Controller 101 proceeds to step 205 where a parent folder of the default folder displayed in step 202 is displayed on the display 111. Then, the process shown in FIG. 2 ends. For example, referring to FIGS. 6A and 6B, when a move-up icon 601 is selected and then an action key is pressed while a My Pictures folder is displayed, a My Items folder (a parent folder of the My Pictures folder) is displayed on the display 111.

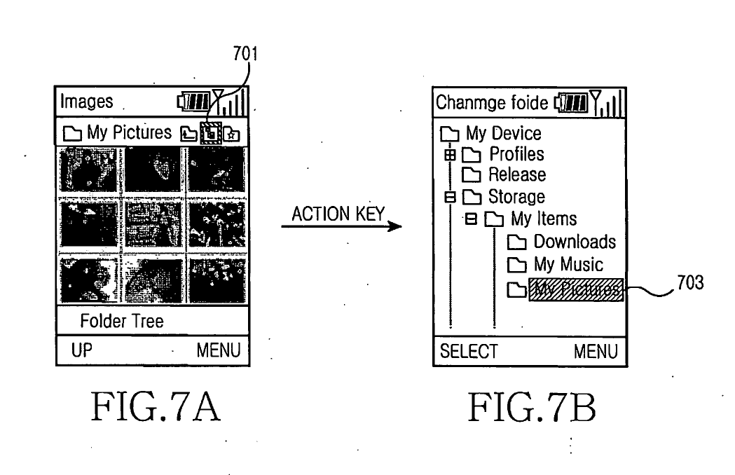

When the folder tree icon is selected in step 203, the Controller 101 proceeds to step 207 where the folder tree is entirely displayed on the display 111. In step 211, it is determined whether a folder is selected by a user using a key. If so, the Controller 101 proceeds to step 213 where the selected folder is displayed on the display 111. Then, the process shown in FIG. 2 ends. For example, referring to FIGS. 7A and 7B, when a folder tree icon 701 is selected and an action key is pressed during a My Pictures folder is displayed, an entire hierarchical structure is displayed on the display 111 using a folder tree. Here, a user can select a desired folder (e.g., My Pictures folder 703 in FIG. 7B) in the hierarchical structure, and then move into the selected folder by pressing a selection key.

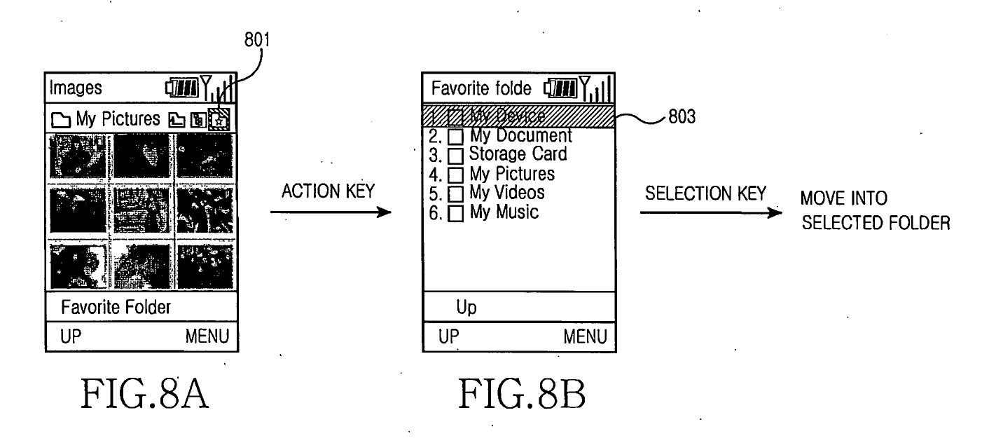

When the favorite folder icon is selected in step 203, the Controller 101 proceeds to step 209 where a stored favorite folder is displayed on the display 111. One or more favorite folders (frequently used folders) can be previously stored, and then one of the stored favorite folders can be selected. In step 211, it is determined whether a user selects a folder. If so, the controller 101 proceeds to step 213 where the selected folder is displayed on the display 111. Then, the process shown in FIG. 2 ends. For example, referring to FIGS. 8A and 8B, when a favorite folder icon 801 is selected and an action key is pressed while a My Pictures folder is displayed, the display 111 displays previously stored favorite folders such as My Device, My Document, Storage Card, My Pictures, My Videos, and My Music folders. A user can move to one of the displayed folders (e.g., My Device 803) using a selection key.

If a function icon is not selected in step 203, the controller 101 performs a default function.

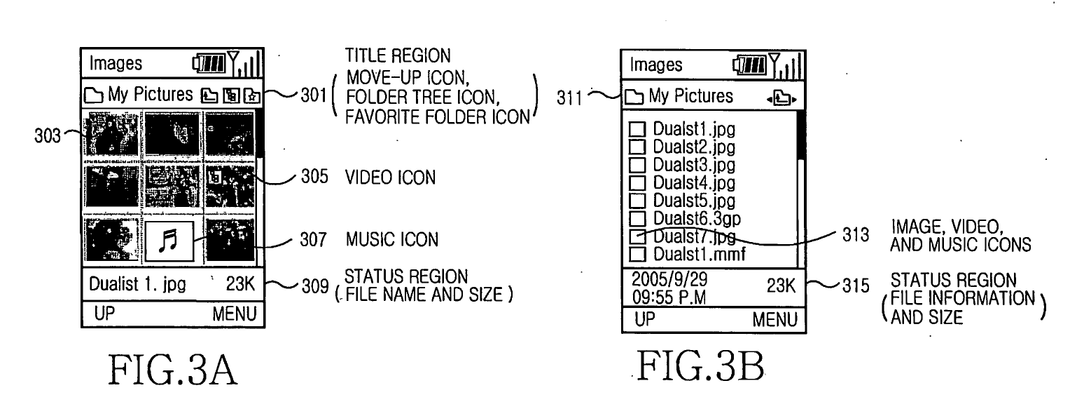

Referring to FIGS. 3A and 3B, a thumbnail view and a list view are shown. In each of the thumbnail view and the list view of FIGS. 3A and 3B, a screen is divided into three regions. A first region (title region) provides information about the current file hierarchical structure and function icons, a second region (content region) provides information about files contained in the current folder, and a third region (status region) provides information about a function icon or file selected by a user using the keypad 109. Referring to FIG. 3A, in the thumbnail view, a title region 301 provides information about the location of a selected folder (e.g., phone, storage card, and HDD), a folder name, and functional icons. A content region provides thumbnail images corresponding to stored image files, video files, and music files at a reduced size. Here, a video icon 305 can be added to a thumbnail image indicating a video file distinguishing it from a thumbnail image for an image file, and a music icon 307 can be used for a music file instead of a thumbnail image. A status region 309 provides information about a selected function icon or a file. For example, when a certain thumbnail image 303 is selected, information about a file corresponding to the selected thumbnail image 303, such as a file name and a file size, is displayed in the status region 309. In the case where a certain function icon is selected, an explanation for the selected function icon is provided in status region 309.

Referring to FIG. 3B, in the list view, a title region 311 provides information about the location of a selected folder (e.g., phone, storage card, and HDD), a folder name, and functional icons. A content region provides a file name list and icons 311 indicating the types of the listed files such as image, video, and music. A status region 315 provides information about a selected function icon or a file. For example, when a certain file is selected, information about the selected file, such as the name and size of the selected file, is displayed in the status region 315. In the case where a certain function icon is selected, an explanation for the selected function icon is provided in status region 315.

Depending on a desired screen layout, all of the function icons can be displayed like in the title region 301 shown in FIG. 3A, or selected function icon(s) can only be displayed in the title region 311 shown in FIG. 3B. In the former case, selected function icons are indicated differently than unselected function icons. In the latter case, existence of other function icons is indicated. Although various function icons can be used, a few of them, such as move up to a parent folder, open a folder tree, and open a favorite folder, are used in the present invention for illustration purposes.

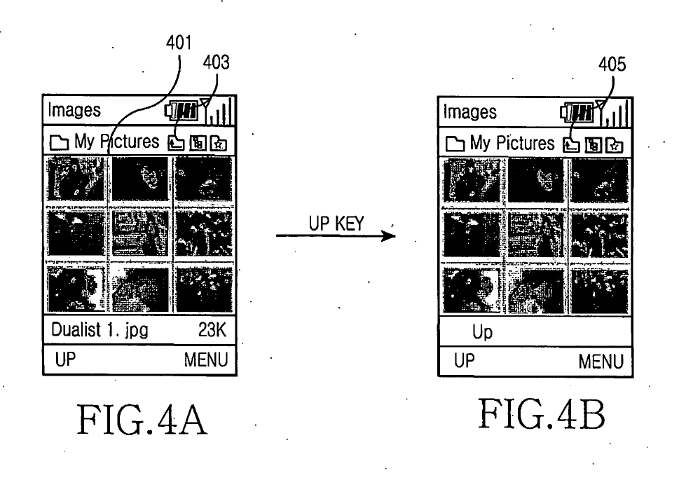

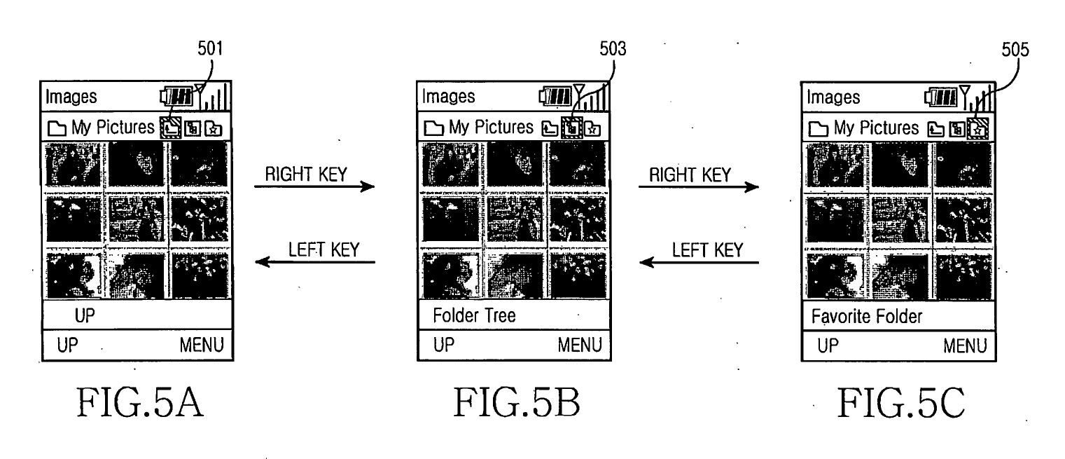

Referring to FIGS. 4A and 4B, a user can move from an uppermost thumbnail image 401 in a content region to a currently selected function icon 403 in a title region by using an up key, or he/she can move from a lowermost thumbnail image in the content region to the currently selected function icon 403 in the title region by using a down key. In FIG. 4B, reference numeral 405 is used to denote the currently selected function key when focus is moved to the currently selected function key. Further, referring to FIGS. 5A through 5C, focus can be switched among function icons 501, 503, and 505 using left and right keys.

As described above, according to the present invention, a hierarchically structured file can be efficiently searched in an information terminal by providing functional icons such as a move-up icon, a folder tree icon, and a favorite folder icon, as well as a basic navigation key for moving to a parent folder or a child folder. Therefore, a user can rapidly and exactly move to a desired location on the hierarchical file, and thus a small-sized screen can be efficiently used.

While the invention has been shown and described with reference to certain preferred embodiments thereof, it will be understood by those skilled in the art that various changes in form and details may be made therein without departing from the spirit and scope of the invention as further defined by the appended claims.

What is claimed is:

1. A method of displaying a hierarchically structured file in an information terminal, comprising the steps of:
selecting a file; and
displaying information about the selected file and at least one function icon in a first region, and information of a folder including the selected file in a second region.

2. The method of claim 1, further comprising the step of performing a function corresponding to a selected function icon.

3. The method of claim 1, wherein the information about the function icon and the selected file are displayed separately.

4. The method of claim 1, wherein the function icon comprises one or more of a move-up icon for moving to a parent folder, a folder tree icon for displaying an entire folder hierarchical structure, and a favorite folder icon for displaying a frequently used folder list.

5. The method of claim 2, wherein if a function icon is selected, the selected function icon is indicated differently from other function icons for distinction.

6. The method of claim 1, further comprising the step of displaying only a currently selected function icon of the function icons on the first region.

7. The method of claim 6, wherein existence of other function icons is indicated using a predetermined symbol.

8. The method of claim 1, wherein the displaying step comprises displaying a thumbnail image or an icon corresponding to an image file, a video file, or a music file included in the current folder on the second region.

9. The method of claim 1, wherein the displaying steps comprises displaying a file list of the current folder on the second region.

10. The method of claim 1, further comprising moving focus to a currently selected function icon in the first region when an up key is pressed at an uppermost icon or file information item in the second region or a down key is pressed at a lowermost icon or file information item in the second region.

11. An information terminal for displaying a hierarchically structured file comprising:
an input means for selecting a file; and
a controller for displaying information about the selected file and at least one function icon in a first region, and information of a folder including the selected file in a second region.

12. The terminal of claim 11, wherein the controller further performs a function corresponding to a selected function icon.

13. The terminal of claim 11, further comprising a display unit for displaying the selected file and the function icon and the information about the folder.

14. The terminal of claim 11, wherein the function icon comprises one or more of a move-up icon for moving to a parent folder, a folder tree icon for displaying an entire folder hierarchical structure, and a favorite folder icon for displaying a frequently used folder list.

15. The terminal of claim 11, wherein the controller further performs displaying a thumbnail image or an icon corresponding to an image file, a video file, or a music file included in the current folder on the second region.

16. The terminal of claim 11, wherein the controller further performs displaying a file list of the current folder on the second region.

17. The terminal of claim 11, wherein the controller further performs moving focus to a currently selected function icon in the first region when an up key is pressed at an uppermost icon or file information item in the second region or a down key is pressed at a lowermost icon or file information item in the second region.
